(19) United States
(12) Patent Application Publication
(10) Pub. No.: US 2007/0206030 A1
(43) Pub. Date: Sep. 6, 2007

(54) Graphical user interface for three-dimensional manipulation of a part

(75) Inventor: Lawrence J. Lukis, Wayzata, MN (US)

Correspondence Address: SHEWCHUK IP SERVICES, 533 77TH STREET WEST, EAGAN, MN, 55121, US

(73) Assignee: The Protomold Company, Inc., Maple Plain, MN (US)

(21) Appl. No.: 11/368,590

(22) Filed: Mar. 6, 2006

(51) Int. Cl. G09G 5/00

(52) U.S. Cl. 345/653

(57) ABSTRACT

A software method allows a user to manipulate a three-dimensional object, particularly a custom designed part to be injection molded, on a computer screen with a mouse. The object or part is manipulatable about a center of rotation. The center of rotation is established on a face of the part, perhaps with a snapping feature to position the center of rotation on an edge of the part. A click-drag-drop rotation of the part is achieved based upon a spherical coordinate map of rotation, allowing the user to repositioning the object rendering. The spherical coordinate map of rotation repositions itself relative to the object based upon a pan command changing the view of the object. The preferred spherical coordinate map of rotation is an orientation globe which appears as an overlay during the click-drag-drop command. The pole of the orientation globe corresponds with a z-axis of the injection molded part or pull direction of the injection mold, and has an initial or default position tilted directly toward the viewer, such as at a 30° tilt.

### CROSS-REFERENCE TO RELATED APPLICATION(S)

None.

### BACKGROUND OF THE INVENTION

The present invention relates to three-dimensional software rendering of parts, such as in Computer Aided Design (CAD) of the part. The present invention finds particular application in the field of software supported methods, systems and tools used in the design and fabrication of molds for custom plastic parts, and in presenting information to customers for the customer to make selections to help minimize the cost of the mold and running the customer's part.

CAD software systems, and particularly CAD systems and viewers which provide a solid model or three-dimensional rendering of the part being designed or viewed, have been in use for decades. Commercial examples of such systems include AUTOCAD, SOLIDWORKS, PRO/ENGINEER, UNIGRAPHICS, AUTODESK INVENTOR, PARASOLID, I-DEAS, STEP, IGES, ACIS, TURBOCAD, EDRAWINGS and VISI-CAD. A common feature existing in virtually all of these software packages is that the part being designed or communicated to another user can be viewed, in a graphical user interface on the computer screen, from a variety of angles and orientations. A “pan” command is commonly used to enable to user to shift the rendering of the part in a desired direction (right, left, up or down or combinations thereof) on the computer monitor. A “zoom” command is commonly used to enable the user to change the scale of the rendering, enlarging or shrinking the rendering of the part on the computer monitor. Though the pan and zoom commands can be menu or keystroke driven, they can also usually be mouse-driven. The most typical pan command, for example, is achieved by positioning the mouse over a location on the part rendering, and then clicking and dragging that location of the part to a different location on the computer screen.

When a three-dimensional part is being designed, the software packages also commonly have some sort of a rotational aspect, to changing the viewing angle of the rendering on the computer screen. The commands for such three-dimensional angular manipulation of the part differ between different software programs, but also commonly involve a click-drag-drop command with a mouse, perhaps first activating a “rotate” command. However, the ways in which the click-drag-drop “rotate” command performs the three-dimensional angular manipulation of the part differs between software programs, and is generally not fully intuitive to the user. Often it takes numerous click-drag-drop commands to effect the orientation manipulation desired, both because of imprecision in the click-drag-drop command and because of the learning curve for the various software packages. Even experienced users of such software programs often fail to understand just how the angular manipulation works, and each reorientation of the part is an interative “just keep trying until it looks right” type of procedure. A better system of angular manipulation of a part is needed.

Injection molding, among other types of molding techniques, is commonly utilized to produce plastic parts from molds. Companies and individuals engaged in fabricating molds are commonly referred to as “moldmakers.” The moldmaking art has a long history of fairly gradual innovation and advancement. Molds are designed pursuant to a specification of the part geometry provided by a customer; in many cases, functional aspects of the plastic part also need to be taken into account. Historically, moldmaking involves at least one face-to-face meeting between the moldmaker and the customer, with complex communication between the moldmaker and the customer and complex decisions made by the moldmaker regarding the construct of the mold. More recently, this process has been automated to a significant degree, to assist in transmitting information between the moldmaker and/or the moldmaker's computer system and the customer, thereby realizing significant efficiencies and corresponding price reductions in the manufacture of molds and custom molded parts.

Such automation is described in U.S. patent application Ser. Nos. 11/338,052, 11/114,893, 11/074,388, 11/035,648, 10/970,130, 10/325,286 (now issued as U.S. Pat. No. 6,836,699), and Ser. No. 10/056,755 (now issued as U.S. Pat. No. 6,701,200). A graphical user interface which permits better angular manipulation of the part would find particular applicability in assisting and automating communication regarding the part between the moldmaker and the customer.

### BRIEF SUMMARY OF THE INVENTION

The present invention is a software method for manipulating a three-dimensional object rendering on a computer screen with a mouse which is particularly applicable to a customer's part to be injection molded. The object or part is manipulatable about a center of rotation, but rather than have the center of rotation at the center of the part or at an imaginary reference point outside the part, the center of rotation is established on a face of the part. A click-drag-drop rotation of the part is achieved based upon a spherical coordinate map of rotation, allowing the user to repositioning the object rendering. In one aspect, the spherical coordinate map of rotation is an orientation globe which appears as an overlay during the click-drag-drop command. In another aspect, a pan command repositions the center of rotation (and orientation globe) to a different location or face of the part. In another aspect, the pole of the orientation globe corresponds with a z-axis of the injection molded part or pull direction of the injection mold.

### BRIEF DESCRIPTION OF THE DRAWINGS

FIG. 1 shows an orientation globe for use in the present invention.

FIG. 2 shows the orientation globe of FIG. 1 mapped against Cartesian and radial grid lines depicted the different active areas of the present invention.

FIG. 3 is a perspective view of an exemplary “cam” part desired by a first customer.

FIG. 4 shows an initial orientation of a rendering of the cam part of FIG. 3 in the graphical user interface of the present invention at a “click”.

FIG. 5 shows the final orientation of a rendering of the cam part of FIG. 3 in the graphical user interface of the present invention at a “drop” after a 30° tilt.

FIG. 6 shows the final orientation of a rendering of the cam part of FIG. 3 in the graphical user interface of the present invention at a “drop” after a 60° turn.

FIG. 7 shows the final orientation of a rendering of the cam part of FIG. 3 in the graphical user interface of the present invention at a “drop” after a 120° rotation.

FIG. 8 shows a rendering of the cam part of FIG. 3 in the graphical user interface of the present invention after a “pan”.

FIG. 9 shows the final orientation of a rendering of the panned cam part of FIG. 8 in the graphical user interface of the present invention at a “drop” after a 30° tilt.

FIG. 10 shows the final orientation of a rendering of the panned cam part of FIG. 8 in the graphical user interface of the present invention at a “drop” after a 60° turn.

FIG. 11 shows a rendering of the cam part of FIG. 3 in the graphical user interface of the present invention after a “zoom”.

FIG. 12 shows the final orientation of a rendering of the panned cam part of FIG. 11 in the graphical user interface of the present invention at a “drop” after a 30° tilt.

FIG. 13 shows the final orientation of a rendering of the panned cam part of FIG. 11 in the graphical user interface of the present invention at a “drop” after a 60° turn.

While the above-identified drawing figures set forth one or more preferred embodiments, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

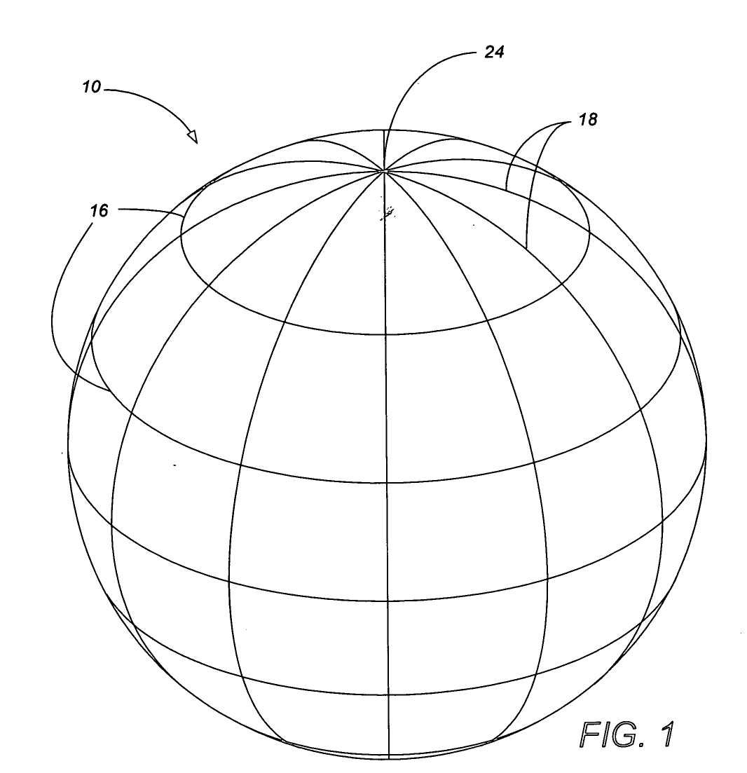

The present invention will be described briefly with regard to how the click-drag-drop command of the inventive system orients an imaginary “orientation globe” 10, and then with regard to how the orientation globe 10 is located with reference to a part rendering 12 shown on a computer screen 14. As called out in FIG. 1, the orientation globe 10 includes latitude lines 16 and longitude lines 18. While the orientation globe 10 shown includes latitude and longitude lines 16, 18 at 30° equal spacing, other spacing could be used for the latitude lines 16, the longitude lines 18, or both. While the orientation globe 10 shown is spherical, a different shape could be equivalently used for the orientation globe 10, such a box shape, a football shape or any other shape which would be recognizable to users to show the orientation of the shape in three dimensions.

The orientation globe 10 represents a first active area on the graphical user interface of the invention. A “click-drag-drop” command with the mouse causes pivoting or rotation of the orientation globe 10 about its spherical center. To change the orientation of the orientation globe 10, the user positions the mouse pointer 20 over any location on the orientation globe 10, and then clicks and drags the clicked location anywhere desired. The rotation of the orientation globe 10 effected is a three-dimensional rotational movement of the orientation globe 10 about its spherical center.

Examples of pivoting algorithms for the orientation globe 10 include Chen's Virtual Trackball, Bell's Virtual Trackball, Shoemake's Arcball, a Two-Axis Valuator Trackball, or 10 a Two Axis Valuator with Fixed Up-Vector. The preferred pivoting algorithm should be as similar as possible to a track ball, wherein the mouse pointer 20 “sticks” to the orientation globe 10 to push or pull the orientation globe 10 as naturally as possible about its spherical center. In this way, mouse manipulation of the orientation globe 10 is intuitive and straight forward.

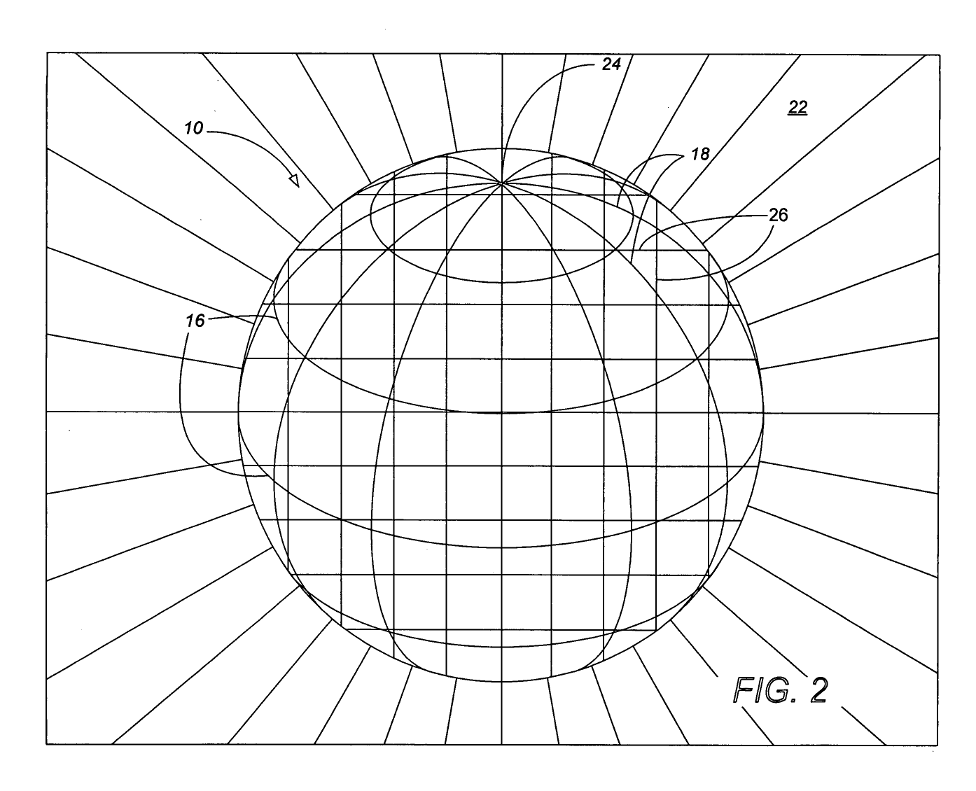

As shown further with regard to FIG. 2, regions on the screen 14 outside the orientation globe 10 represent a second active area 22 on the graphical user interface of the invention. Any “click-drag-drop” command which travels circumferentially in the second active area 22 results in a rotation of the orientation globe 10 about a central axis perpendicular to the screen 14. Radial movement of the mouse pointer 20 in the second active area 22 during a “click-drag-drop” command, or any radial component of movement, causes no effect on the orientation globe 10.

The orientation globe 10 is shown in FIGS. 1 and 2 in the preferred initial or default orientation, that of having the “north” pole 24 tilted 30° directly toward the viewer. With the orientation globe 10 in this tilted position, each spot viewed on the globe 10 can be mapped between its Cartesian coordinates on the computer screen 14 and its latitude/longitude location on the orientation globe 10. By the addition of vertical and horizontal grid lines 26 over the orientation globe 10 as shown in FIG. 2, it can readily be seen that each x, y location of the mouse pointer 20 positioned over the orientation globe 10 maps to a unique latitude/longitude globe position, covering one hemisphere of the orientation globe 10.

Multiple “click-drag-drop” commands can be handled in either of two ways. In the preferred system, the tilt, slant and E-W location are stored in memory, and the orientation globe 10 always reappears for a subsequent rotate command in the position it was last left.

Retaining the tilt, slant and E-W location of the orientation globe 10 in memory is particularly appropriate when applied to an injection molded part 12, wherein the directions (particularly the z-direction) have meaning (the z- or pull direction of the mold) in the forming process for the part 12. Alternatively, the orientation globe 10 may reposition itself for each new rotate command to the preferred starting position (30° forward tilt, °0 slant).

The intuitive nature of the orientation globe 10 is particularly evident when the orientation globe concept is applied to three-dimensional renderings of parts, such as parts to be injection molded. When applied to a part 12, the manipulation of the drawing of the part 12 is linked to the manipulation of the orientation globe 10. The important linking parameters are locating the part 12 relative to the center of rotation 28 of the orientation globe 10, orienting the polar axis 24 and sizing the orientation globe 10 relative to the part 12.

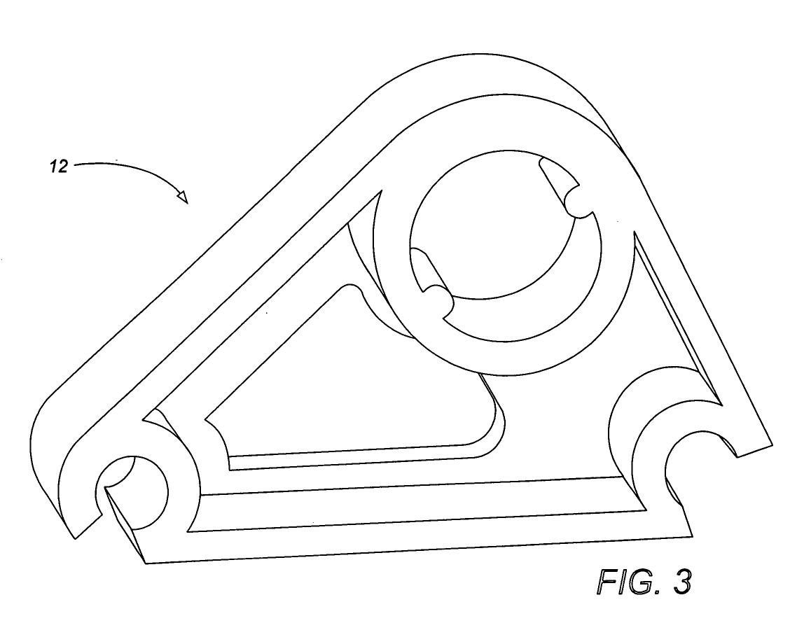

FIG. 3 shows an exemplary part 12 for discussion purposes of the inventive way in which the orientation globe 10 is linked to the part 12, in this case a “cam” part 12 custom designed by a customer. In part because the cam is custom-designed (i.e., not a staple article of commerce) by or for this particular customer, the cam 12 includes numerous features, none of which have commonly accepted names. Without commonly accepted names for these features, verbal communication about changes to one or more features of the cam part 12 is difficult. The graphical user interface of the present invention is particularly contemplated to communicate changes or injection molding requirements of the part.

The quoting of the mold and/or manufacture for the part 12 may generally proceed with automated systems and methods such as described in U.S. patent application Ser. Nos. P 439.12-9, 11/338,052, 11/114,893, 11/074,388, 11/035,648, 10/970,130, 10/325,286 (now issued as U.S. Pat. No. 6,836,699), and Ser. No. 10/056,755 (now issued as U.S. Pat. No. 6,701,200), all incorporated by reference herein. In these applications, a basic step is receiving customer part data comprising a CAD file for the part 12 to be molded, with the CAD file defining a part surface profile. The part 12 is custom designed by or for the customer, and its shape is unknown at the time the computer system housing the invention and software of the invention is finalized. When it is desired to give the customer feedback with regard to the part 12 and how well it will work for injection molding, the customer is provided with a viewer and a simplified CAD file data set which uses the graphical user interface of the present invention.

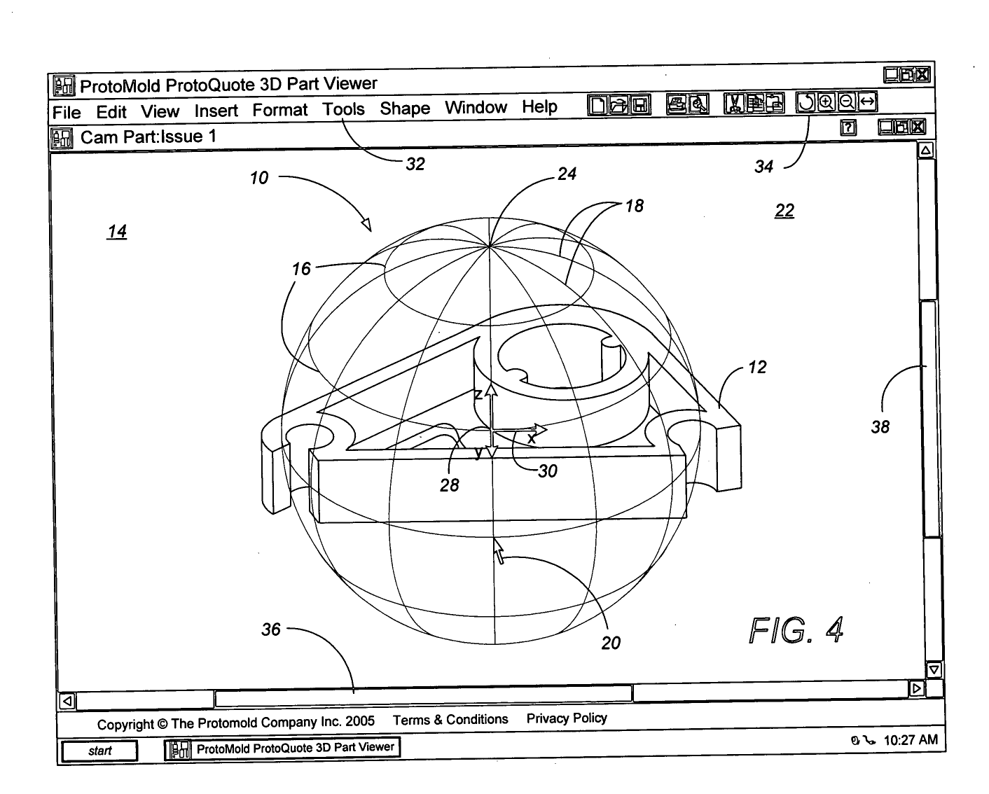

A basic step in determining how to render the part 12 is to align the initial polar axis 24 relative to the part 12. In the preferred embodiment, the initial polar axis 24 is aligned parallel to a z-axis of the part 12, with the axes of the part 12 determined by hand or as described in U.S. Pat. Nos. 6,836,699 and 6,701,200 to best match the way the part 12 will be formed in the injection mold. The y-axis of the part 12 is initially aligned directly toward the viewer subject to the initial tilt of the polar axis 24. The x-axis of the part 12 is therefore initially within the screen plane. FIG. 4 shows the cam part 12 in the graphical user interface, reoriented to this initial position.

Another basic step in determining how to render the part 12 is to locate the part 12 relative to the center of rotation 28 of the orientation globe 10. The center of rotation 28 of the orientation globe 10 equates to a point that cannot be moved on the part rendering 12, with the rest of the part 12 pivoting or rotating around the center of rotation 28 during the rotate command. Rather than place the center of rotation 28 of the orientation globe 10 either at the center of the part 12 or at some imaginary location which is off the part 12, as done in many prior art three-dimensional graphical user interfaces, the present invention in one aspect always places the center of rotation 28 of the orientation globe 10 on a surface of the part 12. Placing the center of rotation 28 on a surface of the part 12 is very important in achieving an intuitive look and feel to the three-dimensional manipulation of the part 12 in the graphical user interface.

The exact location on the surface of the part 12 for positioning of the center of rotation 28 can be selected in any of several alternative ways. In a first embodiment, the center of rotation 28 is placed at the center of the view screen 14, or on the location on the part 12 closest to the center of the view screen 14. In such a centering of view screen embodiment, panning of the part 12 moves the center of rotation 28 on the part 12. A second alternative is to have the user place the center of rotation 28 on a surface of the part 12. For instance, a first step in activating the “rotate” command can be for the user to place the center of rotation 28 on the part 12 at the desired location. A third alternative is to place the center of rotation 28 in the center of an “active” face on the part 12, whereby the user can click on any face of the part 12 to make that face “active”. The preferred embodiment employs a combination of these features, wherein the center of rotation 28 is positioned near the center of the view screen 14, with a tendency to snap to either an edge of the part 12 or the center of a face which is closest to the center of the view screen 14. This embodiment is depicted in FIG. 4, wherein a center of rotation symbol 30 is located on the edge nearest the center of the view screen 14. The preferred center of rotation symbol 30 is a set of arrows that show the x-, y- and z-axes of the part 12. Each of the arrows may be displayed in different colors or otherwise labeled so the viewer can identify which axis is which. Once placed in this default position, the user can manually click and move the center of rotation symbol 30 if a different position for the center of rotation 28 is desired, in which case the center of rotation 28 again maps onto a surface of the part 12. The center of rotation 28 may either be displayed or not displayed on the part 12, but either way defines the center of the orientation globe 10 during the rotate command.

A third basic step in using the orientation globe positioning of the present invention is to define the size of the orientation globe 10 relative to the part 12. One alternative is to make the radius of the orientation globe 10 reach to the furthest extent of the part 12. Another alternative is to have the orientation globe 10 sized in accordance with a set scale retained with the part 12, e.g., a diameter of 3 inches would work well with most injection molded parts. Yet another alternative is to have the orientation globe 10 sized in accordance with the computer window showing the part 12, e.g. 80% of the height of the window. In the preferred embodiment, the orientation globe 10 is sized a set number of pixels, such as a diameter of 300 pixels. This way the size of the orientation globe 10 does not change if the user (such as with a WINDOWS operating system) resizes the computer window smaller than full screen 14. At the same time, the size of the orientation globe 10 is not affected by zooming in or out on the part 12.

Once these three basic steps are established, use of the orientation globe method of the present invention is simple and straightforward. A user merely activates the rotate command, such as through either of default of “rotate on”, through a menu 32 or through a menu button 34, and then the user performs the “click-drag-drop” operation. The part 12 rotates identically to the E-W, tilt and slant rotation of the orientation globe 10, about the center of rotation 28. In the preferred embodiment, a lightly lined or white lined orientation globe 10 appears on the screen 14 during the “click-drag-drop” command. This is shown in the series of FIGS. 4-12, wherein FIG. 4 shows the screen 14 at an initial position, with the remaining figures showing the graphical user interface after manipulation of the orientation globe 10 or part 12. The default x-y-z orientation of the part 12 relative to the screen 14 and relative to the orientation globe 10 provides a very natural viewpoint for injection molded parts. While default positions other than 30° tilt, 0° slant of the z-axis and x and y axis oriented as shown in FIG. 4 could be used, the preferred default positions work well in depicting an injection molded part.

Both the orientation globe 10 and the part 12 are depicted at their instantaneous location throughout the click-drag-drop command. The preferred embodiment shows the orientation globe 10 in light lines or a white-line overlay during user manipulation of the part 12, which then disappears from the screen 14 after the drop (and thus is not shown before the “click” of the rotate command).

A close inspection of FIGS. 4-12 depicts several features of the preferred embodiment of the invention. As shown in FIG. 4, the snapping feature to position the center of rotation 28 on an edge (where two faces meet) positions the center of rotation 28 slightly lower and to the left of the midpoint of the part 12 and the midpoint of the screen 14. This “off-center” aspect can be identified in FIG. 4 in that more of the part 12 is exposed to the right of the orientation globe 10 than to the left of the orientation globe 10.

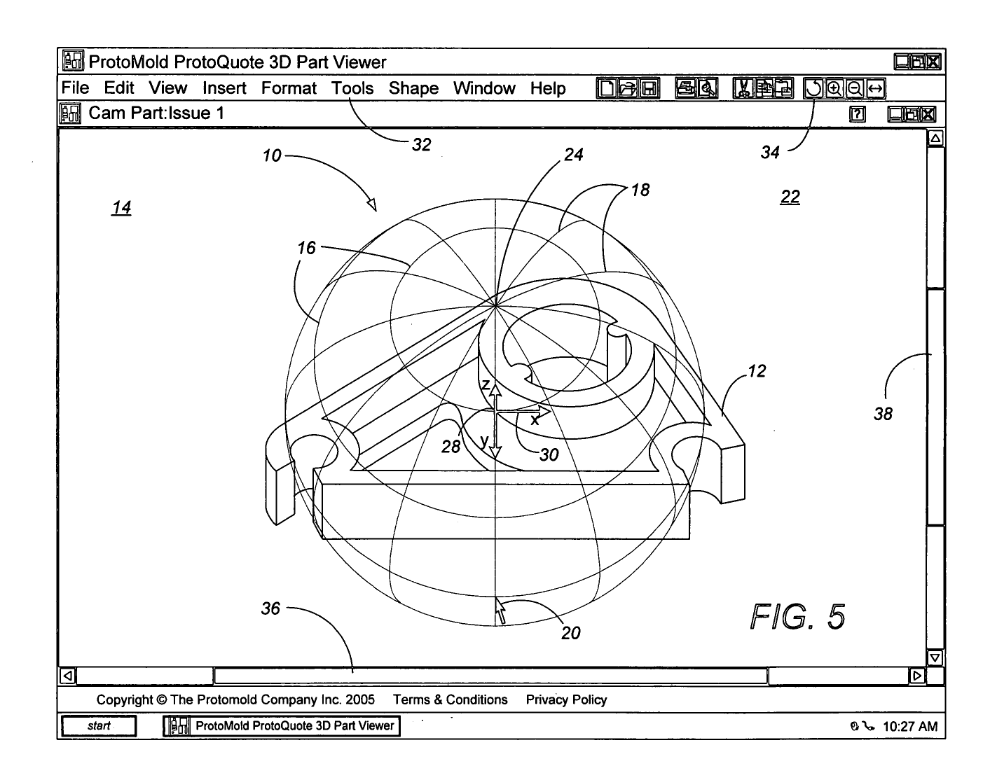

As shown by comparing FIGS. 4 and 5, the user has performed a “click-drag-drop” command with the mouse pointer 20 to pull the orientation globe 10 so the polar axis 24 of the orientation globe 10 has pivoted from a 30° tilt to a 60° tilt. The rotation command has resulted in rotation about the center of rotation 28, so roughly half of the part 12 has rotated in 3-D toward the viewer while roughly half of the part 12 has rotated away from the viewer. The mouse pointer 20 has remained in its clicked position on the orientation globe 10 as the part 12 has pivoted behind it.

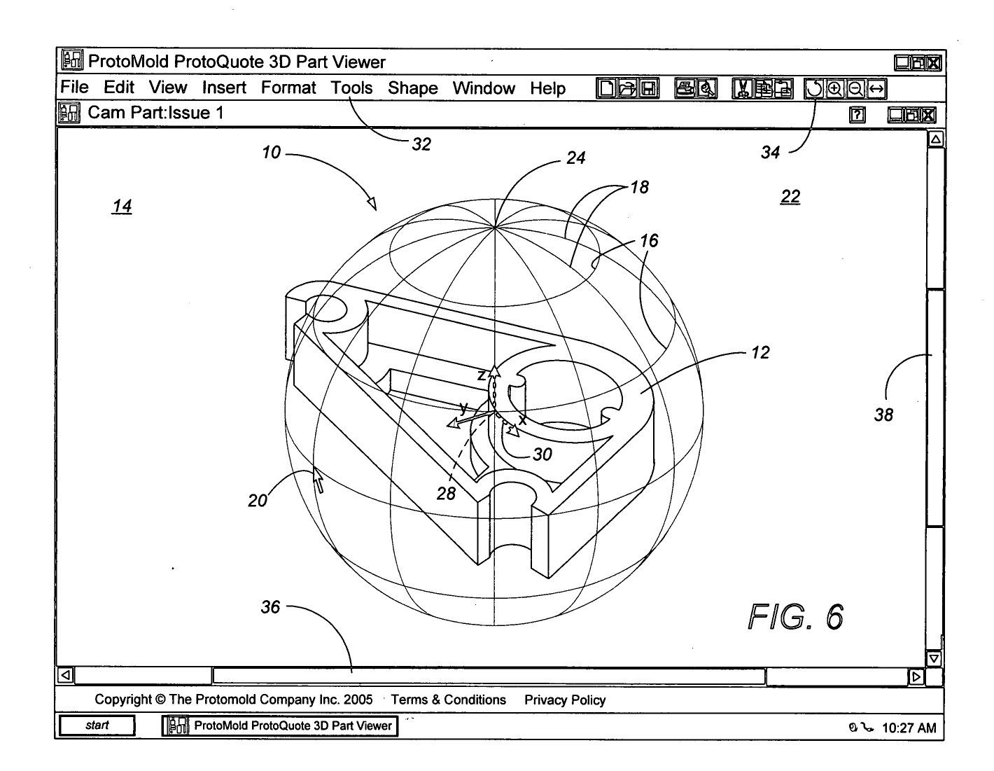

As shown by comparing FIGS. 4 and 6, the user has performed a “click-drag-drop” command with the mouse pointer 20 to effect a 60° turn of the part 12 about the polar axis 24 (z-axis of the part 12). With this 60° turn, the location of the center of rotation 28 becomes hidden from view. The center of rotation symbol 30 may none-the-less be displayed to the user through the part wall, perhaps in lighter shading to indicate that the face upon which the center of rotation 28 rests cannot be viewed in this orientation of the part 12.

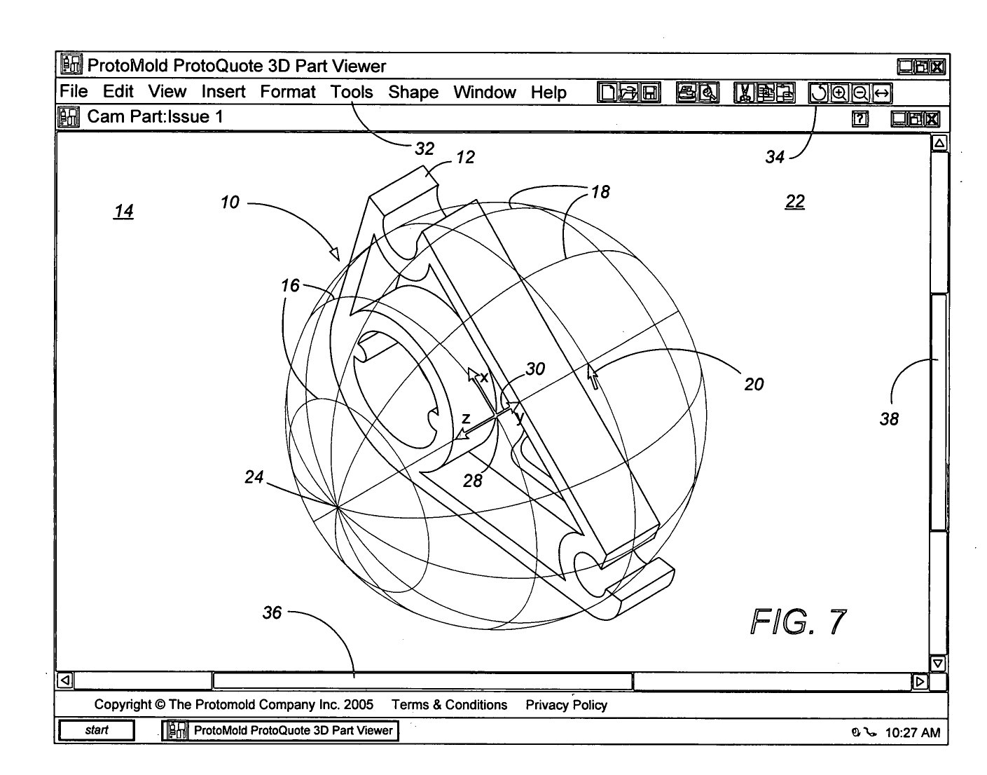

As shown by comparing FIGS. 4 and 7, the user has performed a “click-drag-drop” command with the mouse pointer 20 to effect a 120° rotation of the part 12 about an axis perpendicular to the screen 14. Such a rotation could be achieved either with the mouse pointer 20 on the globe 10 as shown or through a “click-drag-drop” path traveling in the second active area 22. With the orientation globe 10 appearing on the screen 14 and moving with the part 12 during the “click-drag-drop” command path, it is very easy for users to learn and master three-dimensional manipulation of the part 12 to any desired viewing angle.

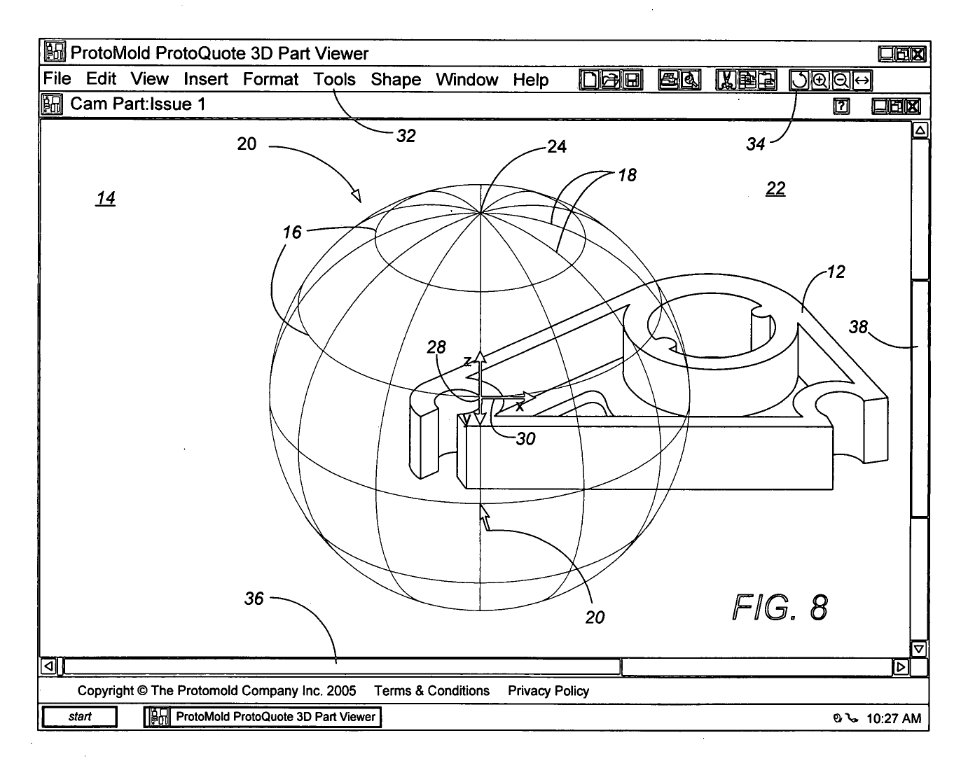

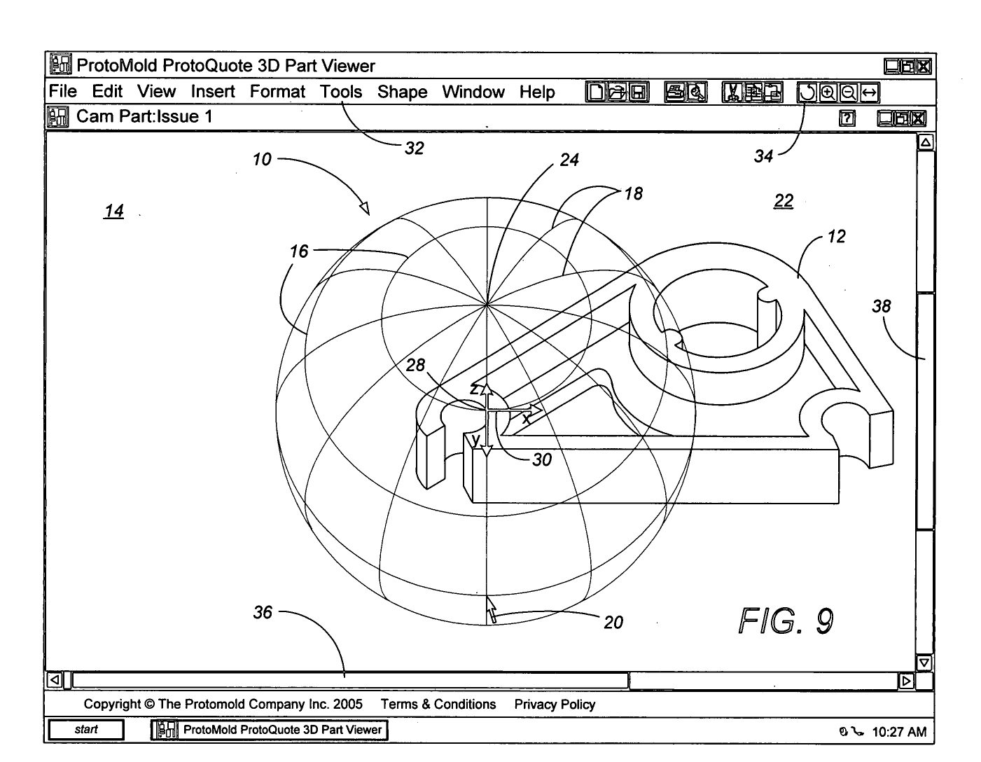

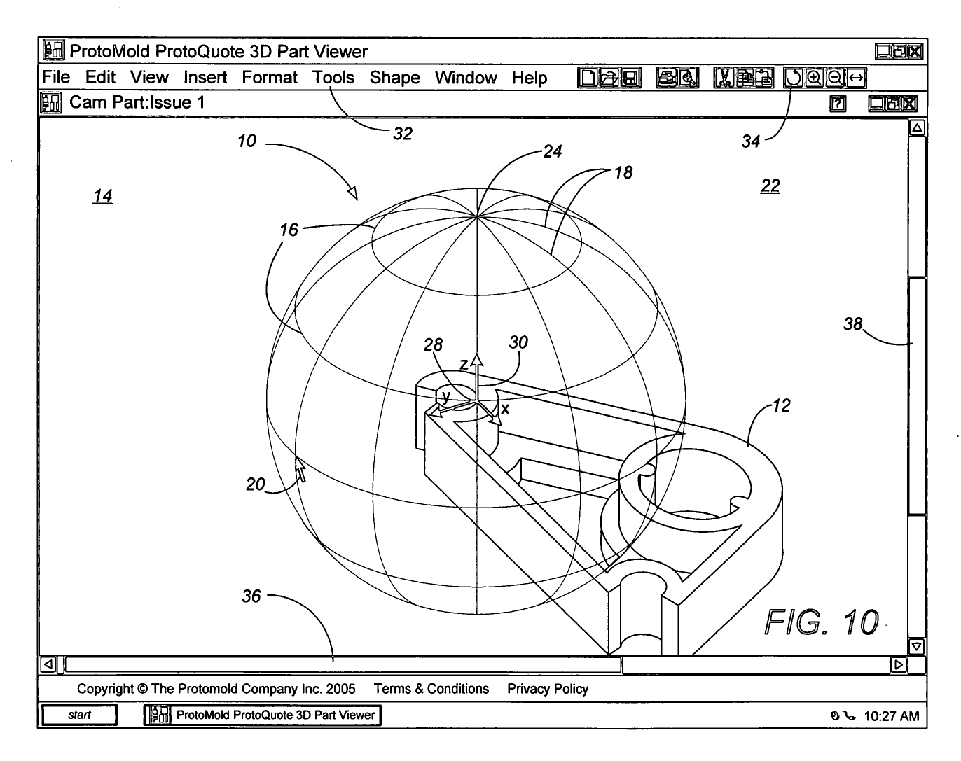

FIGS. 8-10 depict the rendering of the part 12 after the user has performed a “pan” command to the left, i.e., move the part 12 to the right. The effect of the pan is reflected in the bottom scroll bar 36, which has shifted to the left to reflect that the screen 14 depicts the left side of the view. With this pan of the part 12, the center of rotation 28 has attached at a different location on the part 12 at the edge which (after the pan) was closest to the center of the view screen 14. FIGS. 9 and 10 reflect identical “click-drag-drop” commands on the orientation globe 10 as FIGS. 5 and 6, i.e., a net 30° increase in tilt and a net 60° turn about the polar axis 24, respectively. Note that the part 12 has taken different positions on the screen 14 as a result of these identical commands. While the part 12 was at the identical height from FIG. 4 after the pan command of FIG. 8, the part 12 is depicted higher on the view screen 14 in FIG. 9 than in FIG. 5, because more of the part 12 has rotated behind the center of rotation 28. The part 12 is depicted to the right and lower on the view screen 14 in FIG. 10 than in FIG. 6, because more of the part 12 rotated forward relative to the center of rotation 28 at the 30° tilt angle.

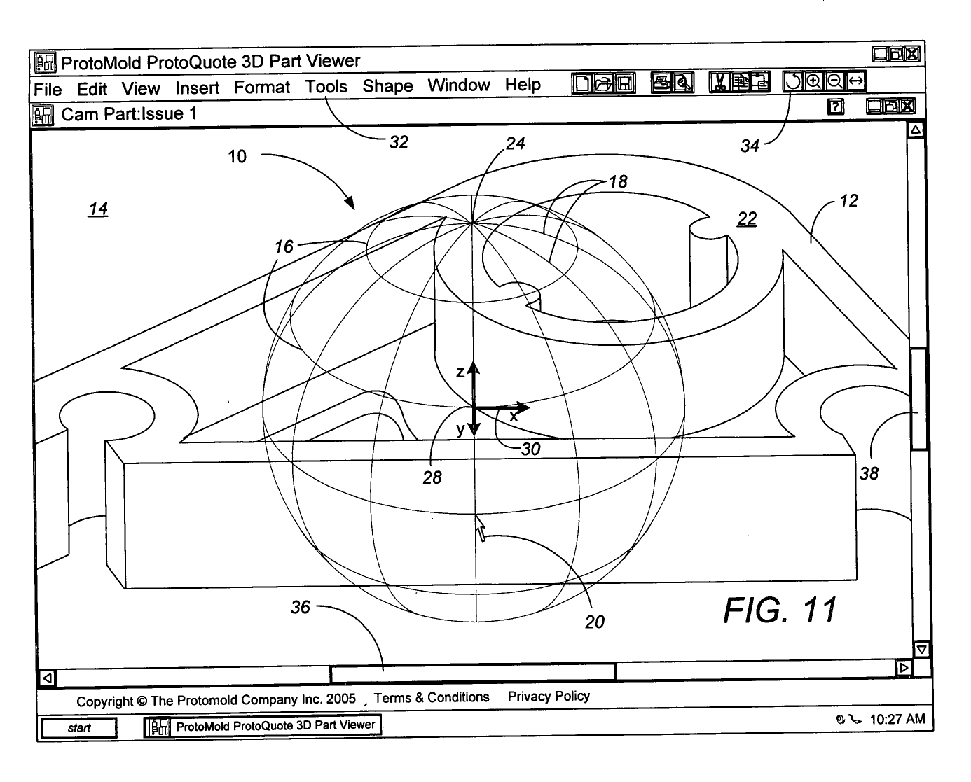

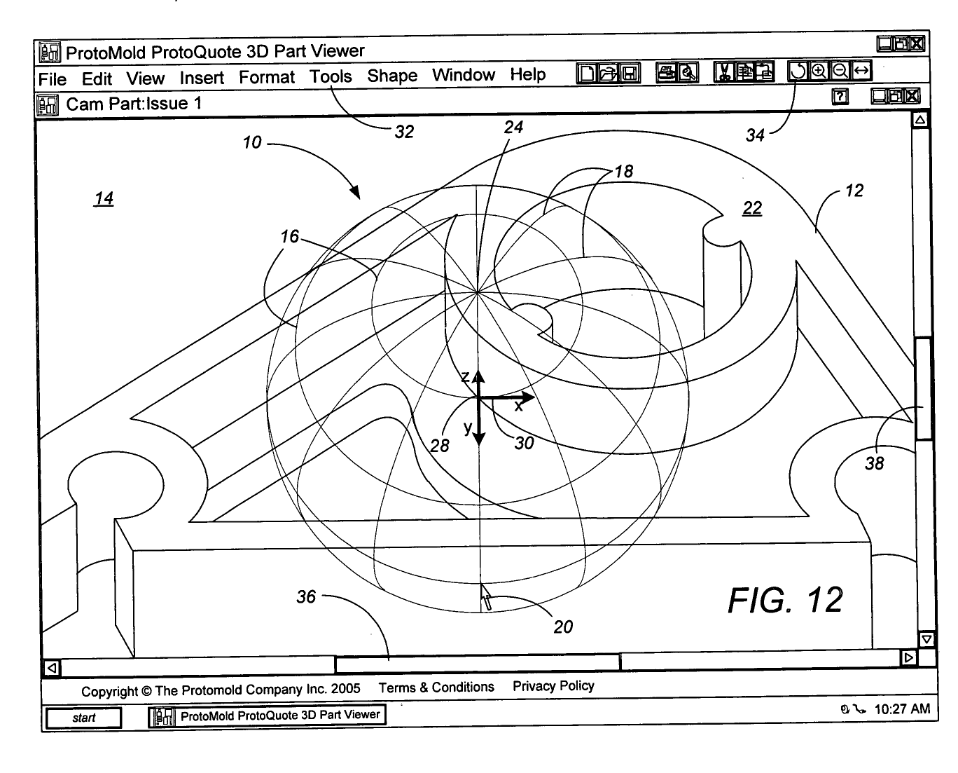

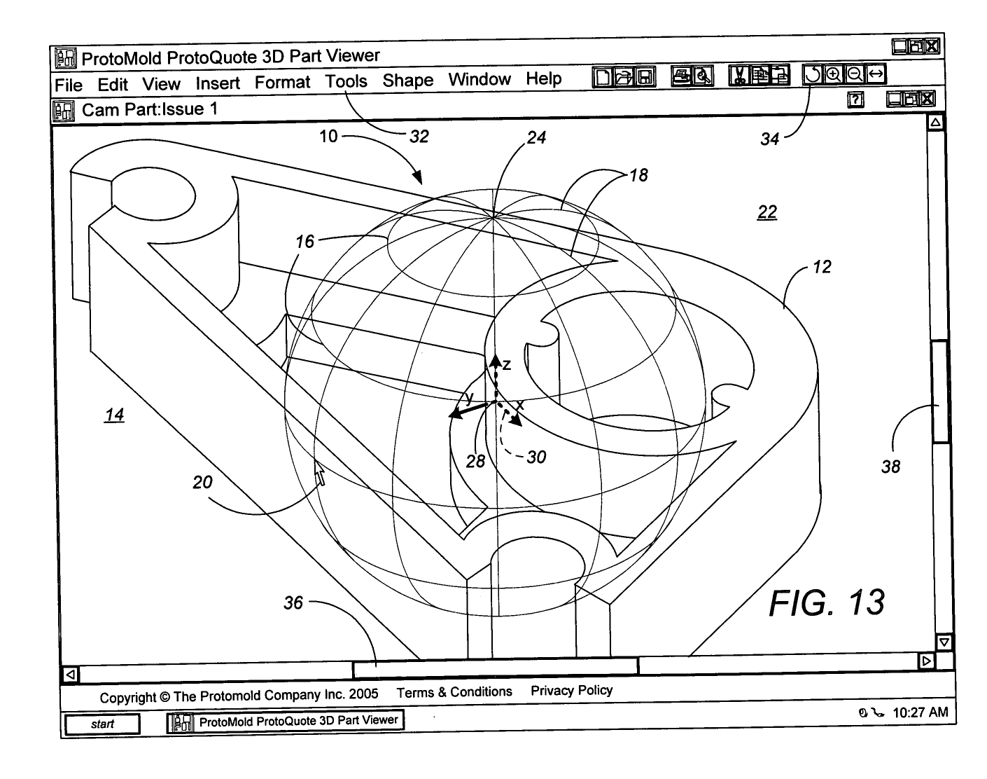

FIGS. 11-13 depict the rendering of the part 12 after the user has performed a “zoom” command to enlarge the part 12 on the view screen 14 to 200%. The effect of the zoom is reflected both in the bottom scroll bar 36 and in the side scroll bar 38, which reflect that a smaller footprint is shown on the screen 14. FIGS. 12 and 13 reflect identical “click-drag-drop” commands on the orientation globe 10 as FIGS. 5 and 6, i.e., a net 30° increase in tilt and a net 60° turn about the polar axis 24, respectively. The orientation globe 10 has not changed in size due to the zooming in on the part 12. The same “click-drag-drop” path—which appears shorter relative to the enlarged size of the part 12 as viewed—will still cause the same angular rotation of the part 12 about the center of rotation 28. If the orientation globe 10 were not shown during the rotate command, the user would not expect the relatively short click-drag-drop path to cause such a powerful change in part orientation. By showing the orientation globe 10, the movement of the part 12 as following the orientation globe 10 is much more intuitive and expected.

Thus it will be seen that the various aspects of the present invention combine to create a graphical user interface which provides an intuitive and powerful 3-D rotational manipulation of an object, and particularly a part to be injection molded. By having a rotation algorithm based upon the orientation globe 10, by showing the orientation globe 10 during the rotate command, by attaching the orientation globe 10 to a face of the part 12, and/or by having pan and zoom commands which interact with the size and positioning of the orientation globe 10 in an intuitive way, the 3-D rotational manipulation functions much better than 3-D rotational manipulation algorithms of the prior art.

Although the present invention has been described with reference to preferred embodiments, workers skilled in the art will recognize that changes may be made in form and detail without departing from the spirit and scope of the invention.

1. A software method for manipulating a three-dimensional object rendering on a computer screen with a mouse, comprising:
providing a three-dimensional drawing of the object on the computer screen, the three-dimensional drawing of the object being depicted with an x-direction, a y-direction and a z-direction;
jointly establishing a center of rotation on a viewed surface of the object on the computer screen together with a generally spherical coordinate map of rotation about the center of rotation; and
based upon a click-drag-drop operation of the mouse within the spherical coordinate map of rotation, repositioning the object rendering via rotation of all viewable surfaces of the object about the center of rotation so the clicked coordinates on the spherical coordinate map of rotation are repositioned to the dropped coordinates on the spherical coordinate map of rotation.

2. The software method of claim 1, further comprising:
displaying latitude and longitude lines of the spherical coordinate map of rotation during the click-drag-drop operation.

3. The software method of claim 1, wherein the center of rotation is established as a center of an active face of the object.

4. The software method of claim 1, wherein the center of rotation is established as an active point clicked on the object.

5. The software method of claim 1, wherein the center of rotation snaps to an edge of the object.

6. The software method of claim 1, wherein the center of rotation is established as a location centered relative to the screen view.

7. The software method of claim 1, wherein the diameter of the spherical coordinate map of rotation is a set ratio of screen view size.

8. The software method of claim 1, wherein the radius of the spherical coordinate map of rotation is equal to the furthest extent of the object from the center of rotation.

9. The software method of claim 1, wherein the diameter of the spherical coordinate map of rotation is a set number of pixels.

10. The software method of claim 1, wherein dragging the mouse off the spherical coordinate map of rotation results in two-dimensional rotation of the object about the center of rotation.

11. The software method of claim 1, wherein the object is a customer's custom part to be injection molded.

12. The software method of claim 11, further comprising:
orienting the z-direction of the object in accordance with a determined pull direction of the injection mold.

13. The software method of claim 12, further comprising:
providing an initial or default view of the object which tilts the z-axis of the object toward the viewer.

14. A method for manipulating a three-dimensional rendering of a part on a computer screen with a mouse, comprising:
providing a three-dimensional drawing of the part on the computer screen;
selecting a center of rotation of the part;
during a click-drag-drop operation of the mouse, displaying an overlay object uniformly positioned relative to the center of rotation, with rotation of the part resulting from the click-drag-drop operation being linked to rotation of the overlay object both about the center of rotation.

15. The method of claim 14, wherein the overlay object is an orientation globe having latitude lines and longitude lines.

16. The method of claim 14, wherein panning of the part on the computer screen to change the location of the part relative to the computer screen changes the location of the center of rotation and linked overlay object relative to the part.

17. The method of claim 14, wherein zooming of the part on the computer screen to enlarge the part relative to the computer screen does not change the size of the overlay object relative to the computer screen.

18. A method for manipulating a three-dimensional rendering of a part on a computer screen with a mouse, comprising:
providing a three-dimensional drawing of the part on the computer screen;
selecting a center of rotation of the part, the center of rotation being selected being dependent upon the x- and y-location of the part on the computer screen, such that panning of the part on the computer screen to change the location of the part relative to the computer screen changes the location of the center of rotation;
rotating the part about the center of rotation via a click-drag-drop operation of the mouse.

19. The method of claim 18, wherein zooming of the part on the computer screen to enlarge the part relative to the computer screen does not change the rotational effect of any given click-drag-drop path which causes rotation.

20. The method of claim 19, wherein an orientation globe appears on the screen during the click-drag-drop operation, wherein the diameter of the orientation globe remains constant regardless of zooming of the part, wherein rotation of the part via the click-drag-drop operation of the mouse also equivalently rotates the orientation globe.
